(19) United States
(12) Patent Application Publication
(10) Pub. No.: US 2011/0069269 A1
(43) Pub. Date: Mar. 24, 2011

(54) CONTINUOUS DOMAIN VERTICAL ALIGNMENT LIQUID CRYSTAL DISPLAY PANEL

(75) Inventors: SHENG-CHANG CHEN, Miao-Li County (TW); WEN-MING HUNG, Miao-Li County (TW); YU-CHENG LIN, Miao-Li County (TW); YUNG-HSUN WU, Miao-Li County (TW); CHUEH-JU CHEN, Miao-Li County (TW); CHIU-LIEN YANG, Miao-Li County (TW); JIA-PANG PANG, Miao-Li County (TW)

(73) Assignee: CHIMEI INNOLUX CORPORATION, Miao-Li County (TW)

(21) Appl. No.: 12/855,786

(22) Filed: Aug. 13, 2010

(30) Foreign Application Priority Data
Sep. 18, 2009 (CN) 200910307224.6

(51) Int. Cl. G02F 1/1343

(52) U.S. Cl. 349/139

(57) ABSTRACT

A continuous domain vertical alignment liquid crystal display panel includes a first substrate and a second substrate opposing to the first substrate. The first substrate includes a first electrode and a number of protrusions disposed on the first electrode. The second substrate includes a second electrode and a number of slits defined in the second electrode. Each protrusion is adjacent to at least one slit, and one of the adjacent protrusion and slit is extended along a straight line and the other is extended along a sine curve. A baseline is defined passing through 0 degrees and 180 degrees on the sine curve, and an angle between protrusions or slits extended along the sine curve and the baseline is smaller than 25 degrees.

### BACKGROUND

1. Technical Field

The disclosure generally relates to liquid crystal displays (LCDs) panels, and particularly to a continuous domain vertical alignment (CDVA) liquid crystal display panel.

2. Description of Related Art

Popular features of LCDs are that they are thin and light, consume relatively little electrical power and do not cause flickering, so they are widely used in electronic devices such as laptop personal computers, and televisions, wherein a panel is one of the main components of each LCD.

An LCD panel usually includes two opposing substrates and a liquid crystal unit sandwiched therebetween. Electrodes are formed on the surfaces of the two substrates. When voltages are applied to the LCD panel, electric fields are generated between the two substrates. Liquid crystal molecules of the liquid crystal unit are twisted by the electric fields to control the light beams, and display a desired image. However, inclinations of each liquid crystal molecule may differ because of effects of gravity and interactions of the liquid crystals with their surroundings. Therefore, images may appear different when observed from different angles.

In order to compensate for the variation in appearance of images displayed by the LCD panels, vertical alignment liquid crystal display panels have been promoted. Referring to FIG. 6, a typical vertical alignment liquid crystal display panel 1 includes a first substrate 11, a second substrate 12 parallel to the first substrate 11, and a liquid crystal layer 13 sandwiched therebetween. The first substrate 11 includes a first electrode 111 and a plurality of protrusions 112 arranged at an inner surface of the first electrode 111. The second substrate 12 includes a second electrode 121 and a plurality of slits 122 defined in the second electrode 121. The projection of each protrusion 112 perpendicular to the second substrate 12 is between two adjacent slits 122. The liquid crystal layer 13 contacted to the first electrode 111, the second electrode 121, the protrusions 112 and the slits 122 includes a number of liquid crystal molecules 131 having negative dielectric anisotropy. The liquid crystal molecules 131 can be driven by electric fields generated by the first electrode 111 and the second electrode 112.

Also referring to FIG. 6, when the LCD panel 1 is in an off state, and no voltage is applied to it, the liquid crystal molecules 131 adjacent to the protrusions 112 and the slits 122 are inclined relative to the protrusions 112. Most of the light beams passing though the second substrate 12 cannot pass though the first substrate 11, because the light beams do not change their polarization states when passing through the liquid crystal molecules 131. As a result, the LCD panel 1 displays a black image.

Referring to FIG. 7, when the LCD panel 1 is in an on state, voltages are applied thereto, and voltage differences between the first electrode 111 and the second electrode 112 generates electric fields perpendicular to a plane of the liquid crystal unit 13. In addition, electrical field lines adjacent to the slits 122 are generally arced. The liquid crystal molecules 131 are twisted relative perpendicular to the electric fields, and the liquid crystal molecules 131 adjacent to the protrusions 112 are further inclined relative to the protrusions 112. Because of birefringence of the liquid crystal molecules 131 and the further incline between the protrusions 112 and the liquid crystals, the polarization states of the light beams are changed to align with the polarization direction of the first substrate 11. Therefore, light is emitted from the first substrate 11, and the LCD panel 1 displays an image with improved brightness.

Referring to FIG. 8, Because the liquid crystal molecules 131 are oriented in four directions X1, X2, X3 and X4, color shift that would otherwise be manifest in images displayed by the LCD panel 1 is compensated for. In particular, the LCD panel 1 has a more consistent display performance along four different viewing directions corresponding to the directions X1, X2, X3 and X4. That is, the LCD panel 1 attains a display having four domains. However, the four-domain configuration can only ensure desired visual performance in four directions.

In addition, when portions of the LCD panel 1 are in an off state to produce black colors in an image, the liquid crystal molecules 131 are inclined relative to the protrusions 112, the polarization states of some of light beams may be changed to align with the polarization direction of the first substrate 11. Therefore, there may be some light leaks from the first substrate 11, and the LCD panel 1 has a lower contrast ratio.

Therefore, there is room for improvement within the art.

### BRIEF DESCRIPTION OF THE DRAWINGS

Many aspects of the CDVA liquid crystal display panels can be better understood with reference to the following drawings. The components in the drawings are not necessarily drawn to scale, the emphasis instead being placed upon clearly illustrating the principles of the CDVA liquid crystal display panels.

FIG. 1 is a top view of a schematic view of a CDVA liquid crystal panel, according to a first exemplary embodiment.

FIG. 2 is a cross-section view of the CDVA liquid crystal panel of FIG. 1.

FIG. 3 is a schematic view of a sine curve and a base line of the CDVA liquid crystal panel of FIG. 1.

FIG. 4 is a test table obtained from the CDVA liquid crystal panel of FIG. 1, disclosing transmittances and contrast ratio varying with angle between a protrusion of the CDVA liquid crystal panel and a baseline.

FIG. 5 is a top view of a schematic view of a CDVA liquid crystal panel, according to a second exemplary embodiment.

FIG. 6 is a cross-section view of a conventional CDVA liquid crystal panel in an off state.

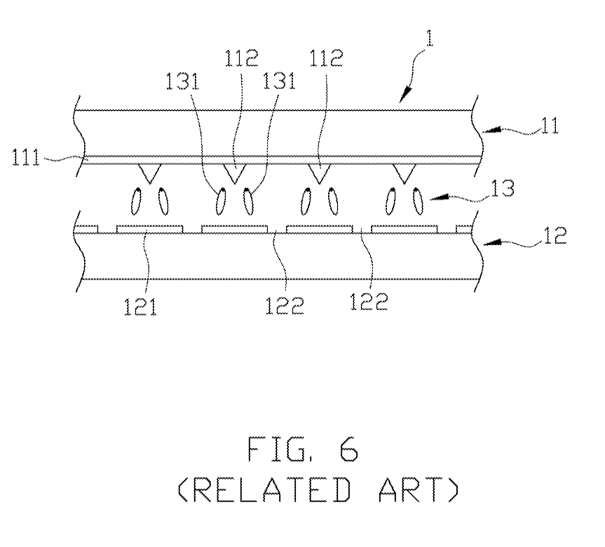

FIG. 7 is a cross-section view of a conventional CDVA liquid crystal panel in an on state.

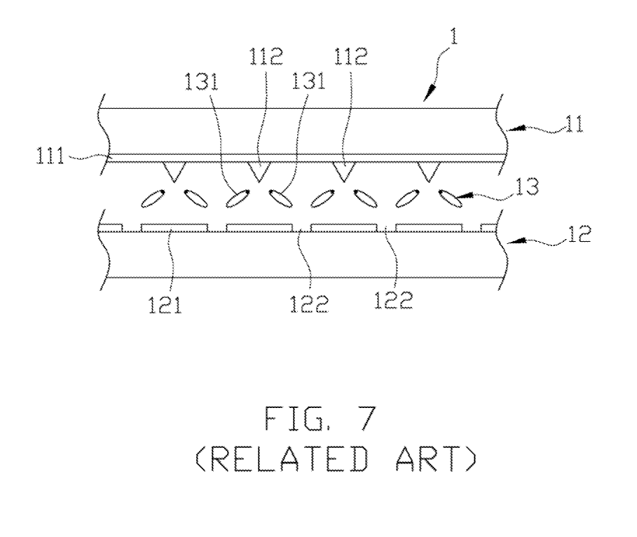

FIG. 8 is a top view of a schematic view of a conventional CDVA liquid crystal panel.

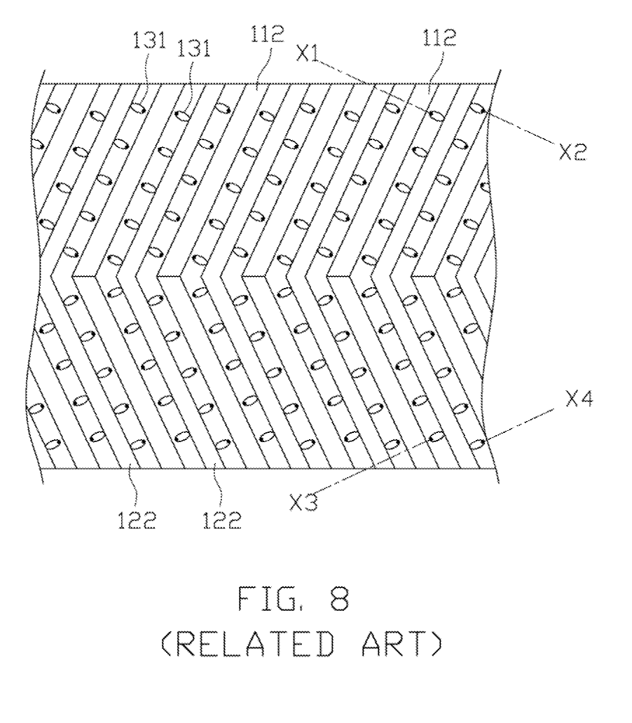

### DETAILED DESCRIPTION

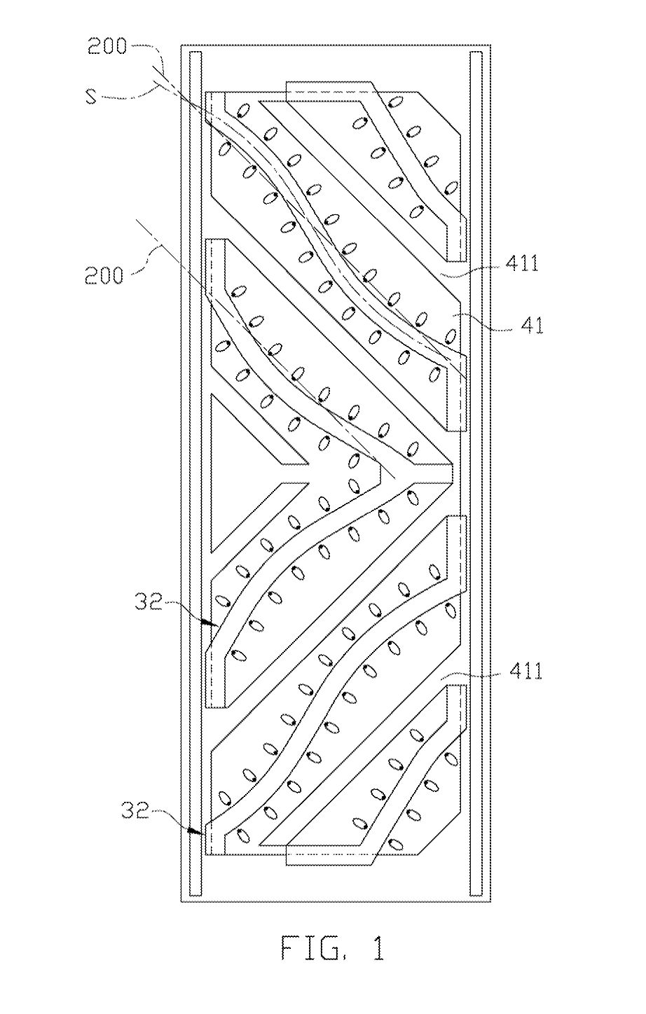

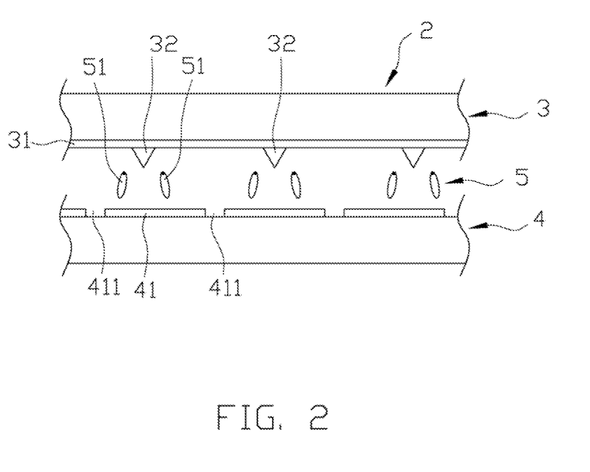

Referring to FIGS. 1 and 2, a CDVA liquid crystal display panel 2 according to a first exemplary embodiment of the present disclosure, includes a first substrate 3, a second substrate 4, and a liquid crystal unit 5.

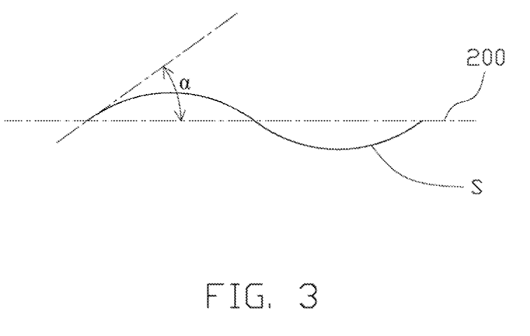

The first substrate 3 includes a first electrode 31 and a plurality of protrusions 32. The protrusions 31 are arranged on the inner surface of the first electrode 31 and spaced from each other. Each protrusion 32 is strip-shaped, and the section width of each protrusion 32 is about 10 μm. Referring to FIG. 2 and FIG. 3, each protrusion 32 is substantially extended along a sine curve S. A base line 200 is defined passing through 0 degrees and 180 degrees on the sine curve S, and an angle α between the protrusion 32 and the base line 200 at 0 degrees on the sine curve S is about 15 degrees. Two ends of the protrusions 32 adjacent to a pixel region (not labeled) are converted to extend along a straight line that is designed as a protruding wing to avoid reducing the transmittance of the CDVA liquid crystal display panel 2.

The second substrate 4 includes a plurality of second electrodes 41 spaced from each other. The second electrodes 41 define a plurality of slits 411. At least one slit 411 is defined adjacent to each protrusion 32. Each slit 411 is extended along a straight line, and the section width of each slit 411 is about 10 μm. The projection of each protrusion 32, perpendicular to the second substrate 4, falls between two adjacent slits 411 and opposite to an electrode 41.

The liquid crystal unit 5 is sandwiched between the first substrate 3 and the second substrate 4, and contacts the first electrodes 31, the second electrodes 41, the slits 411, and the protrusions 32. The liquid crystal unit 5 includes a number of liquid crystal molecules 51 having negative dielectric anisotropy, and can be driven by the electrical fields generated by the first and second electrodes 31, 41.

When the CDVA liquid crystal display 2 is in an off state, and no voltage is applied to it, the liquid crystal molecules 51 adjacent to the protrusions 32 and the slits 411 are inclined relative to the protrusions 32. The liquid crystal molecules 51 arranged along the protrusion 32 includes a plurality of orientations. Most light beams passing though the second substrate 4 cannot pass though the first substrate 3, because the light beams do not change their polarization states when passing through the liquid crystal molecules 51. As a result, the CDVA liquid crystal display 2 displays a black image.

When the CDVA liquid crystal display 2 is in an on state, voltages are applied thereto, and voltage differences between the first electrode 31 and the second electrode 41 generates electric fields perpendicular to a plane of the liquid crystal unit 51. The liquid crystal molecules 51 are twisted relative perpendicular to the electric fields, and the liquid crystal molecules 51 adjacent to the protrusions 32 are further inclined relative to the protrusions 32. Because of birefringence of the liquid crystal molecules 51 and the further incline between the protrusions 32 and the liquid crystals, the polarization states of light beams are changed to align with the polarization direction of the first substrate 3. Therefore light is emitted from the first substrate 3, and the LCD panel 2 displays an image with improved brightness relative to conventional technology.

Because the protrusions 32 are extended along a sine curve S and the slits 411 are extended along a straight line, the liquid crystal molecules 51 are arranged along the sine curve S of the protrusions 32 and have a plurality of inclinations. The plurality of inclinations of the liquid crystal molecules 51 decrease the leaking of light from the LCD panel 2 and raises the contrast ratio when the LCD panel 2 is in the off state, and also improves the color shift when the LCD panel 2 is in the on state.

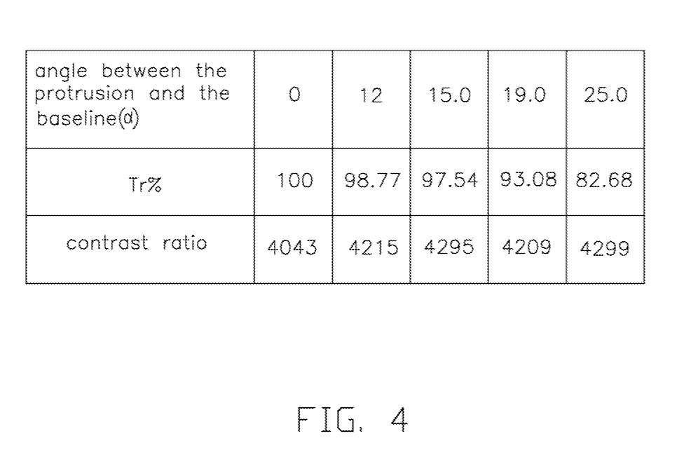

Referring to FIG. 4, when the angle α between the protrusion 32 and the baseline 200 at 0 degrees on the sine curve is 12 degrees, the transmittance is 98.77%, and the contrast ratio is 4215; when the angle α between the protrusion 32 and the baseline 200 at 0 degrees on the sine curve is 25 degrees, the transmittance is down to 82.68, and the contrast ratio is raised to 4299. The angle α between the protrusion 32 and the baseline 200 at 0 degrees on the sine curve is from 10 degrees to 20 degrees in this exemplary embodiment, and more specifically about 15 degrees. In addition, the section width of each protrusion 32 and slit 411 may be from 8 μm to 12 μm.

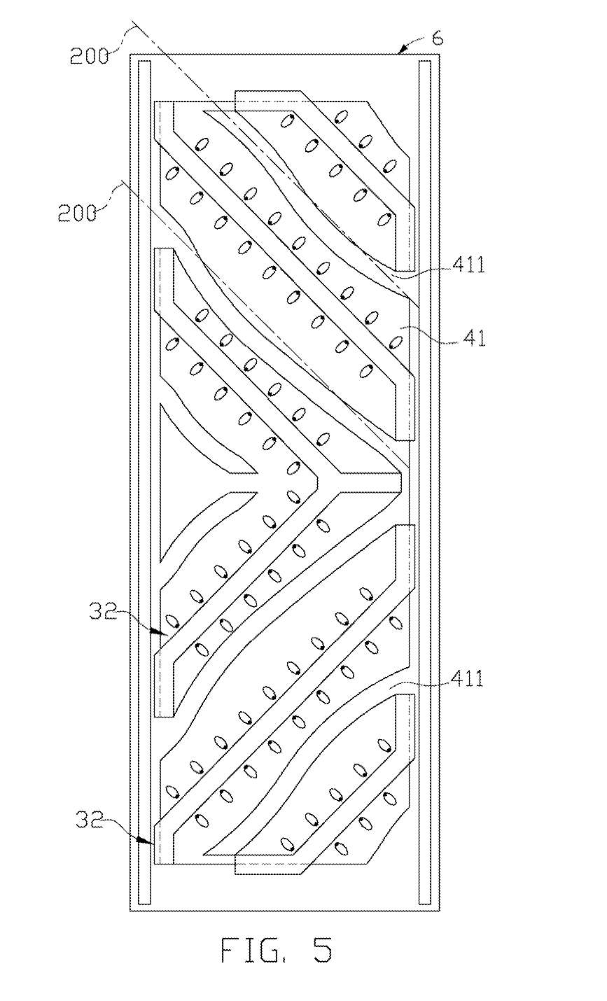

Referring to FIG. 5, a CDVA liquid crystal display panel 6 according to a second exemplary embodiment of the present disclosure is substantially similar to the CDVA liquid crystal displayer panel 2, the difference is that each protrusion 32 of the CDVA liquid crystal displayer panel 6 is extended along a straight line, and each slit 411 of the CDVA liquid crystal displayer panel 6 is extended along a sine curve S. An angle between the slit 411 of the CDVA liquid crystal displayer panel 6 extended along the sine curve S and the baseline 200 at 0 degrees of the sine curve S is smaller than 25 degrees, and is from 10 degrees to 20 degrees in this exemplary embodiment, and more specifically about 15 degrees. The section width of each protrusion 32 and slit 411 may be from 8 μm to 12 μm.

The design of the CDVA liquid crystal display panel 6 with the protrusions 32 extended along a straight line and the slits 411 extended along a sine curve means that the liquid crystal molecules 51 are also arranged along the sine curve of the protrusions 32 and have a plurality of inclinations. The plurality of inclinations of the liquid crystal molecules 51 decrease the leaking of light from the LCD panel 6 and raise the contrast ratio of the LCD panel 6, and also improves the color shift of the LCD panel 6.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A continuous domain vertical alignment liquid crystal display panel, comprising:
a first substrate including a first electrode and a plurality of protrusions disposed on the first electrode; and
a second substrate opposing to the first substrate and including a second electrode and a plurality of slits defined in the second electrode; wherein each protrusion is adjacent to at least one slit, and one of the adjacent protrusion and slit is extended along a straight line and the other is extended along a sine curve; a baseline is defined passing through 0 degrees and 180 degrees on the sine curve, and an angle between protrusions or slits extended along the sine curve and the baseline is smaller than 25 degrees.

2. The continuous domain vertical alignment liquid crystal display panel as claimed in claim 1, wherein the slit is extended along a straight line, and the protrusion is extended along a sine curve.

3. The continuous domain vertical alignment liquid crystal display panel as claimed in claim 2, wherein the baseline corresponding to each protrusion is between two adjacent slits.

4. The continuous domain vertical alignment liquid crystal display panel as claimed in claim 3, wherein distances from the baseline to the two adjacent slit are equal.

5. The continuous domain vertical alignment liquid crystal display panel as claimed in claim 4, wherein the projection of each protrusion perpendicular to the second substrate is fallen between two adjacent slits.

6. The continuous domain vertical alignment liquid crystal display panel as claimed in claim 1, wherein the angel between the protrusions or slits extended along the sine curve and the baseline is from 10 degrees to 20 degrees.

7. The continuous domain vertical alignment liquid crystal display panel as claimed in claim 6, wherein the section width of each protrusion is from 8 μm to 12 μm, the section width of each slit is from 8 μm to 12 μm.

8. The continuous domain vertical alignment liquid crystal display panel as claimed in claim 1, wherein the protrusion is extended along a straight line, and the slit is extended along a sine curve.
